(19) United States
(12) Patent Application Publication
(10) Pub. No.: US 2012/0107578 A1
(43) Pub. Date: May 3, 2012

(54) METHOD AND DEVICE FOR PRODUCING CONSTRUCTION ELEMENTS

(75) Inventor: Michael Brinkmann, Halle (DE)

(73) Assignee: HORMANN KG BROCKHAGEN, Steinhagen (DE)

(21) Appl. No.: 13/381,305

(22) PCT Filed: Jul. 2, 2010
(86) PCT No.: PCT/EP2010/004018

§ 371 Date: Dec. 28, 2011

(30) Foreign Application Priority Data
Jul. 3, 2009 (DE) 10 2009 033 075
Sep. 17, 2009 (DE) 10 2009 041 860.1

(51) Int. Cl. B32B 3/10; B05C 11/00; B05D 5/00

(52) U.S. Cl. 428/195.1; 427/271; 118/44; 427/511

(57) ABSTRACT

Embodiments of the invention relate to a method for producing structural elements exposed to the effects of weather, such as metallic structural elements, in particular sectional door panels, roll-up door slats or the like, in which method the structural elements which may have already been provided with a base coating, are imprinted.

### CROSS REFERENCE TO RELATED APPLICATION

The present application is a national phase entry application under 35 U.S.C. §371 of International Patent Application No. PCT/EP2010/004018, filed Jul. 2, 2010, which designates the United States of America, and which is hereby incorporated by reference in its entirety for all purposes.

### TECHNICAL FIELD

Embodiments of the invention relate to a method for producing structural elements exposed to the effects of weather, such as metallic structural elements, in particular sectional door panels, roll-up door slats or the like.

### BACKGROUND

In many cases, metallic structural elements are used in the area of building facades. Such structural elements are used during the manufacture of doors, for example, in particular sectional doors, the outer boundary surface of which is subjected to the effects of weather when closed. In order to obtain an attractive appearance on the outside, care must be taken to ensure that these structural elements retain their optical characteristics even when subjected to weather effects. For this purpose, structural elements are currently used which are manufactured from sheet metal which undergoes a varnishing and baking process prior to the necessary forming operations in order to preserve the structural elements. The varnish is therefore baked onto the metallic substrate and in this manner receives the desired weathering resistance. To preserve the structural elements, such as sectional door panels, the sheet metal prepared in this manner then undergoes a forming operation, such as a rolling contact forming process, in which the varnished sheet metal is pulled off a coil and then continuously runs through forming rollers. The formed sheet metal is then still filled with foam, if necessary, and is joined with other metal sheets in order to obtain sectional door panels like those described in EP 370 376 A, for example. For this purpose, the varnishing process must be performed such that the varnished surface is not damaged during the forming operation. It may also be necessary that the varnished sheets have to withstand an embossing operation without damage, which precedes the forming operation, and which is performed to provide the sheet metal with “wood grain embossing,” for example.

Structural elements must normally be provided in different colors and decors. For this reason, different inventories of correspondingly pretreated metal sheets must be provided. For some of the requested designs it is also required that foils must be applied onto the pretreated sheet metal and that under certain circumstances these foils also be covered with a protective foil to obtain the desired weathering resistance. This is the case for instance, when the metallic structural elements are to be provided with a decorative wood pattern. In this case, a foil with a decorative wood pattern is applied onto the metallic substrate and subsequently laminated with an acrylate film on top of the decorative foil pattern. The acrylate film can have a thickness of approximately 50μ for this purpose. Here too, appropriately prepared coils of sheet metal must be provided. This is associated with substantial warehousing problems. In view of these problems of the prior art, the object of various embodiments of the invention is to provide processes for producing structural elements, in particular sectional door panels, which are exposed to the effects of weather, and which can provide structural elements that have the desired outer appearance without excessive complexity in terms of warehousing, to indicate corresponding structural elements and to provide an apparatus for performing appropriate methods.

### BRIEF DESCRIPTION OF THE DRAWING

Embodiments of the present invention will be readily understood by the following detailed description in conjunction with the accompanying drawing. Embodiments of the invention are illustrated by way of example and not by way of limitation of the accompanying drawing.

FIG. 1 is a schematic representation of a coating line in accordance with various embodiments of the present invention.

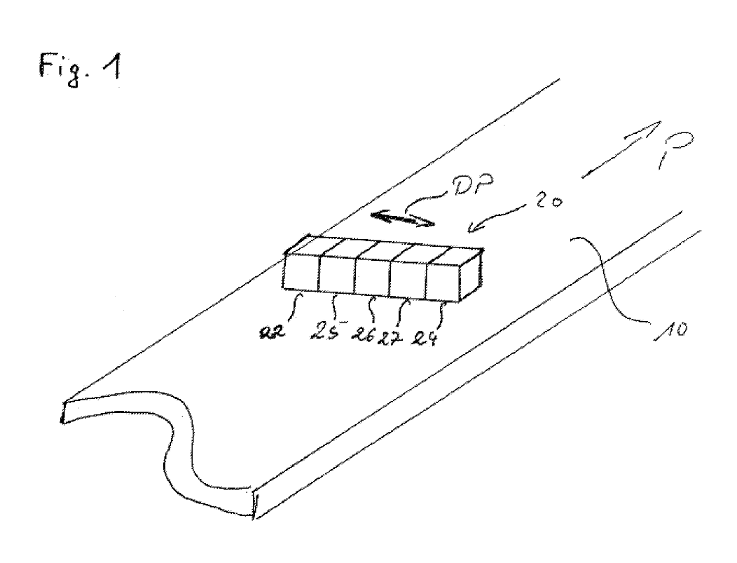

### DETAILED DESCRIPTION OF EMBODIMENTS

Embodiments of the invention teach that this problem is solved by a development of the known methods, which is essentially characterized in that structural elements which are already formed and possibly provided with a base coating, are imprinted.

Embodiments of the invention draw on the knowledge that in order to obtain the desired external appearance it is not necessary to provide the starting materials with the desired decor such as forming, embossing or the like, already prior to processing. It is rather sufficient if the desired decor is applied only after the forming operation has been completed. For this reason, structural elements can be manufactured with any optional external appearance, using one and the same starting material in order to simplify the inventory control overall.

The printing process can be performed computer controlled based upon digital image data. For this reason, the method as taught by various embodiments of the invention can also be used to obtain any optional, customized external appearance of the structural elements. It is also possible to use customer-provided image data, such as JPG files. For this reason, using the method as taught by various embodiments of the invention simplify not only the inventory control but still expands also the variability of the manufacturing operation. In this context, the printing at the end of a production line for continuous production of structural elements can be performed after the forming operation and, if necessary, foam filling of the structural elements, but still prior to cutting the structural elements to the desired length.

In a preferred embodiment of the invention, the imprinting of the structural element surface is done using a printing device like an inkjet printer, wherein a relative motion between the surface of the structural element to be imprinted and a print head is generated, during the course of which at least one ink nozzle of the print head for spraying the ink onto the structural element surface passes the surface to be imprinted. In this manner, by using a simple print head, for example, when using metal sheets with the standard white baked enamel finish as starting material it is possible to create any optional black-and-white motifs on the structural element surfaces. Thus only the black ink will be used. In order to obtain colored illustrations on the structural element surfaces it has proven to be favorable if during the course of the relative motion, two, three, or more ink nozzles of the print head pass the surface to be imprinted in sequence, if necessary. By appropriate adjustment and, if necessary, computer-assisted control of the ink nozzles, motifs of optional form and color can thus be created on the structural element surfaces. In this context, same as in traditional inkjet printers, the three basic colors cyan, magenta, and yellow as well as light magenta and light cyan can be used, if necessary, to obtain optional colors using subtractive mixtures.

For creating the relative motion between the structural element on the one hand and the print head and/or the print heads on the other, the print heads can be moved reciprocally relative to a stationary frame, while the structural element at the same time is moved in a perpendicular direction to the reciprocal motion relative to the print heads and the frame. In a particularly preferred embodiment of the invention, the print head and/or the print heads is/are arranged fixed relative to the frame, wherein the relative motion is performed exclusively by moving the structural element relative to the ink nozzles. The ink nozzles are then controlled depending upon the advance motion of the structural elements for imprinting the structural elements with the mixed motifs. For this purpose, computer-controlled printing systems can be used.

Especially UV-curable inks can be used as inks for the printing process. These inks are cured immediately after spraying and/or application through irradiation with UV radiation in a radiation curing process. During this chemical curing, the initially liquid or low-viscosity ink will be solidified by cross-linking and/or polymerization in an irreversible procedure. If the UV radiation is sufficiently intensive, this curing process can be completed within fractions of a second. For this purpose, the print head preferably comprises a device for provision of UV radiation, so that the ink can be cured immediately after it has been sprayed on. Because of the rapid curing, the printing speed and therefore the throughput speed of the components can be increased. This furthermore makes additional coating possible which follows immediately after the printing process, because it is not necessary to wait for the ink to dry for extended time periods.

Normally, UV curable inks cannot be used for exterior applications since they are not very weather resistant. It must be ensured, however, that the external appearance of the structural elements obtained by imprinting is also resistant when subjected to the effects of weather. For this purpose, the imprinted surface of the structural element is preferably provided with a weather resistant coating. In a particularly preferred embodiment of the invention, the weather resistant coating is applied only after pre-curing of the ink. In this context it was recognized that the application of a weather resistant coating onto the imprinted substrate has no significant influence on the external appearance obtained by the printing process, where potential minor influences can still be compensated for by appropriate modification of the printing process.

The weather resistant coating can be in the form of a weather resistant, preferably transparent special ink or in the form of an essentially transparent clear coating, which can be applied as a liquid, for example.

After the printing process, the external appearance of the structural element obtained thereby can be preserved if the weather resistant coating is sprayed onto the imprinted surface with a coating nozzle that has a preferable nozzle diameter of 50μ or less, particularly 35μ or less. For this purpose, for spraying on the weather resistant coating, a relative motion between the imprinted surface and the coating nozzle can also be generated. Also this relative motion is preferably generated by a motion of the structural elements relative to a fixed frame in the printing device, wherein the coating nozzles are arranged fixed relative to the frame. For this purpose, preferably a plurality of coating nozzles extend in the direction perpendicular to the direction of motion of the structural elements, so that the entire surface of the structural elements can be provided with a weather resistant coating by a simple advance motion of the structural elements.

In a particularly preferred embodiment of the invention, a common relative motion of print head and coating nozzle, relative to the structural elements surface, is generated particularly through the advance motion of the structural elements, during the course of which the surface areas imprinted by the coating nozzle passes after the ink nozzles. This can happen, for example, in that the print head is additionally equipped with the coating nozzle, wherein the coating nozzle is assigned a storage container for the coating material. Ink nozzles and coating nozzles can then be moved together. In the described preferred embodiment of the invention with a fixed print head, the coating nozzle and/or coating nozzles is/are designed as an independent component.

During the course of the printing process, a reciprocating motion of the ink nozzles relative to the surface to be coated can also be generated, wherein the surface to be coated is conveyed in a direction that extends perpendicular to the direction of motion of the ink nozzles relative to the ink nozzles. In this case, it has been found to be especially useful, if at least one coating nozzle is provided on each side of the ink nozzles. Then the printing process with subsequent coating can be performed in each direction of motion such that initially the ink is applied and that the imprinted surface is coated with the coating material immediately thereafter. In this way, the manufacturing process can be distinctly accelerated.

It has been shown that during the manufacturing process for traditional sectional door panels with a width of 400 mm or more transverse to the production flow, a production speed of 10 m/min. or more, preferably 15 m/min. or more, particularly 20 m/min. or more, can be obtained if the structural elements run at a corresponding production speed through the coating line which has at least one print head and at least one coating nozzle for imprinting and coating. To increase the production speed, the coating line can have two, three, or more print heads with corresponding coating nozzles that are arranged adjacent to the direction of printing that is transverse to the direction of throughput, so that only a narrow surface area must be coated by each print head. Then the coating process can be performed with fixed print heads. The method as taught by various embodiments of the invention has also been proven favorable with respect to material savings that can be achieved with it, because it is sufficient if the ink is applied during printing with a thickness of altogether only 15μ or less, preferably 10μ or less, particularly 5μ or less, wherein the desired weathering resistance is obtainable if also the weather resistant coating is applied with a total coating thickness of only 15μ or less, preferably 10μ or less, particularly 5μ or less. The total thickness of ink and coating material can be 30μ or less.

As can be derived from the above explanation, the method as taught by various embodiments of the invention can be integrated into a continuous process for manufacturing of metallic structural elements, in which metal strip that is provided with a base coating, if necessary, can be pulled off a coil in a continuous process, be subjected to processing such as forming, foam filling or the like, be imprinted, coated, and cut to a specified length, if necessary.

A structural element that is obtained with the methods as taught by various embodiments of the invention is essentially characterized in that it has an imprinted surface area, which additionally can be provided with a weather resistant coating.

In particular with so-called sandwich structural elements, in which a heat-insulating core is incorporated between two metal shells, it was found to be problematic if a dark colored external boundary surface of the structural element is exposed to insolation as a result of which it heats up, because thermal stresses are created between the external boundary surface and the inner boundary surface in the structural element, which can produce distortions of the structural element. This effect can be reduced if the base coating, the ink and/or the weather resistant coating has pigments with an especially high reflectivity in the wavelength range above 750 nm, because then a large part of the otherwise absorbed heat radiation in the solar spectrum which produces heating of the structural elements is not absorbed, but instead is reflected without any thermal effect. During the use of appropriate cool color pigments, it has proven to be especially useful, if the average reflectivity (ratio of reflected intensity to irradiated intensity) of the coated structural element surface for electromagnetic waves is in a wavelength range of 750 nm to 2500 nm at an angle of incidence of 45° is 0.1 or more, preferably 0.2 or more, particularly 0.25 or more.

As can be derived from the above explanation, the so-called cool color pigments can be especially advantageously used if the structural element between the imprinted surface and one boundary surface opposite of it is made of a material with lower thermal conductivity, such as polyurethane foam. A sectional door leaf manufactured from structural elements as taught by various embodiments of the invention has a plurality of structural elements that are connected pin-jointed with each other relative to specified articulated axes, where the form of the structural elements in a sectional plane running perpendicular to the pivot axes can correspond to the form of the sectional door panels described in EP 370 376 A.

The sectional door leaf in a sectional door as taught by various embodiments of the invention can be moved in a closed position that is essentially aligned in a vertical plane and between an open position that is essentially aligned in a horizontal plane. For this purpose, the sectional door has in addition to the sectional door leaf, guide rails with a straight line section that runs approximately in the direction of gravity for determining the closed position, a second section for determining the opening position that extends in a straight line in an approximate horizontal direction, and a section that runs horizontally with the section that runs vertically and connects the arched section. In addition, the sectional door can also still have a frame which surrounds the sectional door leaf in the closed position, wherein a pass door can also still be integrated in the sectional door leaf, if necessary.

A coating line as taught by various embodiments of the invention for performing a method as taught by various embodiments of the invention has at least one print head designed for printing on a surface of a metallic structural element that has already been provided with a base coating, if necessary, and preferably in addition with a coating device designed for coating the imprinted surface with a weather resistant coating, particularly a coating nozzle. For this purpose, the coating device can have a storage container containing the coating material and which is assigned to the coating nozzle. To obtain the desired processing characteristics, the coating material can have a solvent such as methoxy propanol, isopropyl alcohol or the like for adjusting the viscosity of the coating material to a desired value. The solvent is volatile in air so that it has no further effect on the characteristics of the coating once the coating process has been completed.

The coating material can be applied with coating nozzles in the form of ink nozzles of traditional inkjet printers, if the viscosity of the coating material is adjusted to a value of 50 mPa s or less, in particular 10 mPa s or less, particularly preferable 5 mPa s. In particular weather resistant, preferably transparent special ink or clear varnish is used as coating material. The clear varnish can in addition to a particularly good weathering resistance also still have high scratch resistance and provide very good UV resistance. It can be applied with a coating thickness of 6 to 7μ, and following the coating process be cured by the effect of UV light exposure. In this context it has been found to be useful if the structural elements to be coated are arranged with the imprinted surface aligned in the direction of gravity and that the clear varnish or the ink is applied from a nozzle from the upper edge of the respectively aligned structural element. The clear varnish or the ink distributes under the influence of gravity across the imprinted structural element surface and can subsequently be UV hardened, if necessary.

In the following, various embodiments of the invention are explained by reference to the drawing, which is not referred to in detail with respect to all details that are essential to various embodiments of the invention and any particulars that are not particularly emphasized in the description. The only FIGURE of the drawing shows a schematic representation of a coating line as taught by various embodiments of the invention.

In the coating line represented in the drawing, a structural element 10 obtained by a forming operation but which has not been cut to specified lengths, which in the drawing is only schematically indicated, is continuously conveyed in the direction indicated by the arrow P below a print head designated overall with 20, wherein the print head can be reciprocally moved perpendicular to the direction of conveyance P designated by the double-headed arrow DP. The print head 20 includes two coating nozzles 22 and 24, each of which is designed for the application of a weather resistant coating onto the surface of the structural element 10, as well as altogether three ink nozzles 25, 26 and 27, each of which is designed for imprinting the structural element with one color, respectively. The coating nozzles 22 and 24 are controlled such that only one of them is used for coating the material section imprinted with the print nozzles 25, 26 and/or 27, according to which this material section was imprinted. Devices can be arranged between the ink nozzles and the coating nozzles for creating UV radiation. The print nozzles are controlled via a computer according to a color print such that the surface of the structural element 10 is imprinted with the desired, customized image data specifying the motifs, for example. In this manner, optional motifs can be provided on the structural element surfaces.

Embodiments of the invention are not limited to the embodiment represented by means of the drawing. It has rather also been considered that two, three or more print heads can be arranged adjacent to the transverse direction of conveyance P, in order to reduce the printing area for each individual print head and thus to increase the overall production speed. Furthermore, methods as taught by various embodiments of the invention can be used not only for imprinting metallic structural elements but also for printing on structural elements made from other materials, such as plastics.

1. A method for producing structural elements exposed to the effects of weather comprising:
optionally providing the structural elements with a base coating; and
imprinting the structural elements.

2. The method according to claim 1, wherein, for the purpose of imprinting, a relative motion is created between the surface of the structural element to be imprinted and a print head, during the course of which at least one ink nozzle of the print head designed for spraying an ink onto the structural element surface passes the surface to be imprinted.

3. The method according to claim 2, wherein during the course of the relative motion, two, three, or more ink nozzles of the print head pass the surface to be imprinted in sequence.

4. The method according to claim 2, wherein following the printing process, the ink is cured, particularly with the aid of UV radiation.

5. The method according to claim 4, wherein the print head includes a device for delivery of UV radiation, so that the ink cures immediately after it is sprayed on.

6. The method according to claim 2, wherein at least one imprinted surface area of the structural elements is provided with a weather resistant coating, after the curing of the ink, wherein the weather resistant coating comprises a weather resistant special ink or a substantially transparent varnish that can be applied in liquid form.

7. The method according to a claim 6, wherein the weather resistant coating is sprayed onto the imprinted surface with a coating nozzle that has a preferable nozzle diameter of 50μ or less, particularly 35μ or less.

8. The method according to claim 7, wherein for spraying on the weather resistant coating, a relative motion between the imprinted surface and the coating nozzle is created.

9. The method according to claim 7, wherein a common relative movement of print head and coating nozzle relative to the structural element surface is created, during the course of which the surface area imprinted by the coating nozzle passes after the ink nozzles.

10. The method according to claim 1, wherein during the imprinting, ink with a coating thickness of altogether 15μ or less, preferably 10μ or less, particularly 5μ or less, is applied.

11. The method according to claim 6, wherein the weather resistant coating is applied with a total thickness of 15μ or less, preferably 10μ or less, particularly 5μ or less.

12. The method according to claim 1, wherein the structural elements for imprinting and coating run through a coating line that has at least one print head and at least one coating nozzle at a throughput speed of preferably 10 m/min. or more, in particular 15 m/min. or more, especially preferably 20 m/min. or more.

13. The method according to claim 1, wherein a metal strip is pulled off a coil in a continuous process, is subjected to processing such as forming, and is subsequently imprinted, coated, and cut to a specified length.

14. A structural element produced with a method according to claim 1.

15. The structural element according to claim 14, wherein the base coat, an ink and/or an weather resistant coating comprises pigments with a particularly high reflectivity in the wavelength range above 750 nm.

16. The structural element according to claim 14, wherein a median reflectivity of the coated structural element surface for electromagnetic waves in the wavelength range of 750 nm and/or 2500 nm at an angle of incidence of 45° amounts to 0.1 or more, preferably 0.2 or more, in particular 0.25 for more.

17. The structural element according to claim 14, wherein a material with low thermal conductivity, such as a polyurethane foam, is arranged between the coated surface and a boundary surface that is opposite of it.

18. A sectional door leaf with a structural element according to claim 14.

19. A sectional door with a sectional door leaf according to claim 18.

20. A coating line for performing a method according to claim 1 with at least one print head designed for imprinting a surface of a metallic structural element that may already have been provided with a base coat.

21. The coating line according to claim 20, wherein the coating line has a coating device, particularly a coating nozzle, designed for coating the imprinted surface with a weather resistant coating.

22. The coating line according to claim 21, wherein the coating device has a storage container which contains the coating material.

23. The coating line according to claim 22, wherein the coating material can includes a solvent such as methoxy propanol, isopropyl alcohol or the like for adjusting the viscosity of the coating material to a desired value.

24. The coating line according to claim 22, wherein the coating material has a viscosity of 50 mPa s or less, preferably 10 mPa s or less, particularly 5 mPa s or less.

25. The method of claim 1, wherein the structural elements comprise metallic structural elements, and wherein the metallic structural elements comprise sectional door panels or roll-up door slats.
